(19) United States
(12) Patent Application Publication
(10) Pub. No.: US 2013/0219166 A1
(43) Pub. Date: Aug. 22, 2013

(54) HARDWARE BASED IDENTITY MANAGER

(71) Applicants: Todor Ristov, San Diego, CA (US); Stuart P. Moskovics, San Diego, CA (US)

(72) Inventors: Todor Ristov, San Diego, CA (US); Stuart P. Moskovics, San Diego, CA (US)

(73) Assignee: MOTOROLA MOBILITY, INC., Libertyville, IL (US)

(21) Appl. No.: 13/400,217

(22) Filed: Feb. 20, 2012

(51) Int. Cl. H04L 9/32

(52) U.S. Cl. 713/151; 713/175; 713/176

(57) ABSTRACT

A method for providing authentication credentials to a server over a communications network includes initiating communication with a server over a communications network. The communication is to be established using a secure connection. A message is received from the server over the communications network as well as a request for a digital certificate associated with a first user account accessible to the server. An encrypted private key is decrypted in a secure hardware module to obtain a decrypted private key. The decrypted private key is associated with the first user account. The message received from the server is passed to the secure hardware module. The message is digitally signed in the secure hardware module using the decrypted private key. The digital certificate and the digitally signed message are sent to the server over the communication network.

### BACKGROUND

To gain access to the ever-growing number of websites that are available to users of communication devices, users often need to establish unique user IDs and passwords for each service that is to be provided. For instance, in many e-commerce environments, an active computer user may have several different accounts with different on-line vendors. For example, a user can have one account with an on-line bank, another account with an on-line travel agent, and further accounts with other service providers, such as a bill paying service, on-line retailer, on-line auction site, and so on. In order to ensure maximum security, a user should select different user ID names and passwords for each different account. In this manner, each separate account is protected in the event that the user ID and password for one account is discovered by an unauthorized third party.

However, maintaining different user identifiers and passwords can become difficult and cumbersome for users who interact with several different on-line sites. Without a convenient system for managing these different passwords and access codes, users may simply adopt a single user ID and password for all of their different accounts and applications. This severely compromises the security of these accounts, since a person who breaks the password for one account can then often access the user's other accounts.

Password managers are often used to address this problem by storing the user's various account credentials. Because of the valuable information they store, password managers can be attractive targets for attackers. To address this security concern, password managers often employ a master password, which is used to protect all the account credentials. The master password is used to derive a key which is used to encrypt the password manager's store.

The design of a password manager involves a tradeoff between security and usability. Prompting a user to enter his master password every time credentials are needed for a particular account would amount to an unpleasant user experience, particularly for password managers used on smartphones, where entering passwords can be burdensome. For this reason the user is generally asked only once for the master password. From that point on the password is kept in the clear in the device's main memory. As a consequence, however, if the device is stolen or lost, a malicious party that misappropriated the device can extract the password by taking a snapshot of the device's main memory. Once the master password is obtained, the malicious party can decrypt the password manager's store and obtain all the account credentials stored in it.

One way to address this problem is make the master password the same as the login password for the device itself. If the device is configured to enter a sleep mode after short period of inactivity, the password store will be encrypted and the master password will be securely deleted from main memory. When the device wakes up, the user once again provides the login password, thereby also providing the master password, which can be used to decrypt the password store. In this way the master password is only in the clear when the device is in an active state. If the period of inactivity that needs to elapse before the device goes to sleep is kept relatively short, the likelihood of the master password being misappropriated can be significantly reduced. However, even if the master password is not in the clear, it can potentially still be obtained by an attacker in other ways. For instance a simple dictionary attack can sometimes succeed since users often choose passwords that are valid, or close to valid, dictionary words.

### BRIEF DESCRIPTION OF THE DRAWINGS

FIG. 1 shows an exemplary operating environment that includes a server and various client devices.

FIG. 2 shows a block diagram of an example of a mobile communication device that is useful for understanding the present invention.

FIG. 3 shows one example of a secure hardware module that may be employed in a client device.

FIGS. 4-5 show one example of a high level architecture of the pertinent components of the mobile device shown in FIG. 2.

FIG. 6 shows one example of the Transport Layer Security (TLS) message exchange process that may be used to establish a secure connection between a client device and a server.

FIG. 7 shows the client architecture of FIGS. 4-5 to illustrate an example of a process flow that may be used by the client device when logging onto the server.

FIG. 8 shows an alternative embodiment in which the hardware-based identity manager (HIM) is hosted on a mobile communication device but used by another device such as a PC to access an account on a server.

FIG. 9 shows a block diagram of an example of a server that is useful for understanding the present invention.

### DETAILED DESCRIPTION

As detailed below, an identity management system is provided which employs secure, tamper-resistant hardware. The secure hardware is leveraged for encryption of the account credentials as well as for secure authentication of a user to a server. Instead of a password, the identity management system makes use of digital certificates for client authentication. Significantly, the system only exposes account credentials in the clear a single time, which is when the user is initially requested to provide his or her credentials for a specific account.

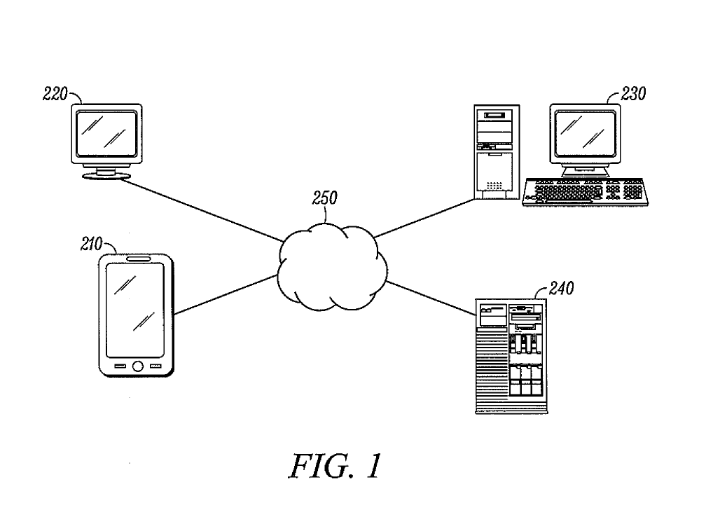

FIG. 1 shows an exemplary operating environment that includes a server 240 and client devices 210, 220 and 230. A communication network 250 connects the devices and applications hosted in the computing environment 200. The communication network 250 can be any type of network, including a local area network (“LAN”), such as an intranet, and a wide area network (“WAN”), such as the internet. Further, the communication network 250 can be a public network, a private network, or a combination thereof. The communication network 250 also can be implemented using any type or types of physical media, including wired communication paths and wireless communication paths associated with multiple service providers. Additionally, the communication network 250 can be configured to support the transmission of messages formatted using a variety of protocols.

The server 240 may be implemented by one or more computing devices arranged to provide the functionality described herein. For example, the server 240 can be implemented as an application instantiated on a suitable processing device, for example on a web server, a network server, at a mobile switching center (MSC), on a base station controller (BSC), or on any other suitable node of the communications network 250. The server 240 can receive from the client devices 210, 220 and 230 requests for access to any of myriad of different services that may be offered by server 240. Such services may involve, by way of illustration only and not as a limitation on the subject matter disclosed herein, computation, software, data access and data storage. Services enabled by the aforementioned products, services and solutions may include, for instance, shopping, banking, selling and collaborating as well as communication and entertainment services.

Client devices 210, 220 and 230 may be any network-enabled device that can communicate with the server 240 over communication network 250. For example, client devices 210, 220 and 230 may be, without limitation, a PC, laptop, netbook, tablet, television, gaming device, landline or wireless telephone, smart phone, media device, alarm clock, kitchen appliance or other dedicated appliance. In FIG. 1 clients 210, 220 and 230 are depicted as a mobile device, a television and a PC, respectively.

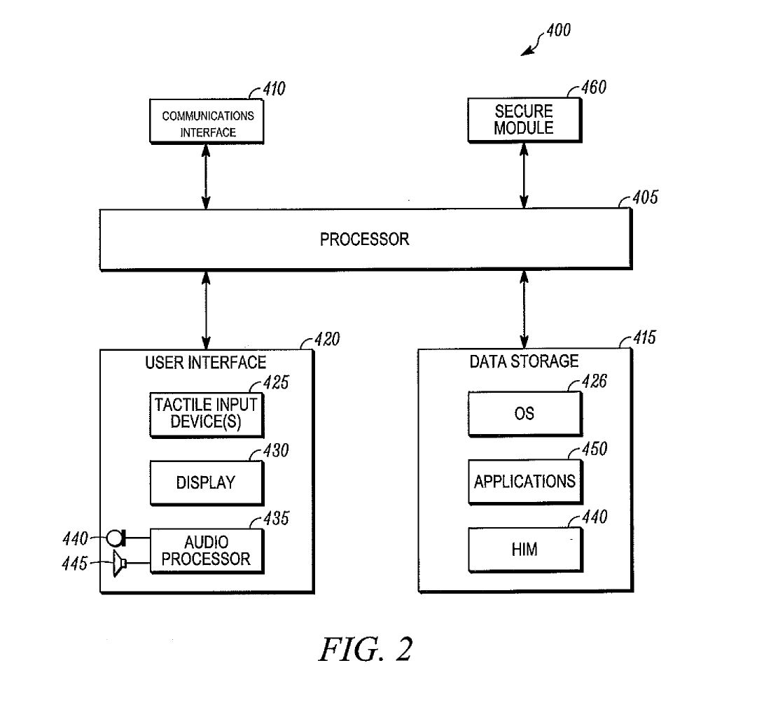

In some examples the mobile device 210 is a mobile communications device such as a wireless telephone that also contains other functions, such as PDA and/or music player functions. To that end the device may support any of a variety of applications, such as a telephone application, a video conferencing application, an e-mail application, an instant messaging application, a blogging application, a digital camera application, a digital video camera application, a web browsing application, a digital music player application, and/or a digital video player application. In some implementations the mobile device 210 may correspond to a mobile device of the type that will be described below in connection with FIG. 2.

FIG. 2 depicts a block diagram of an example of a client device 400, such a client devices 201, 220, and 230, that is useful for understanding the present invention. The client device 400 can include a processor 405. The processor 405 can comprise, for example, one or more central processing units (CPUs), one or more digital signal processors (DSPs), one or more application specific integrated circuits (ASICs), one or more programmable logic devices (PLDs), a plurality of discrete components that can cooperate to process data, and/or any other suitable processing device that executes machine-readable instructions maintained in machine-readable storage media 415, also referred to herein as data storage. In an arrangement in which a plurality of such components are provided, the components can be coupled together to perform various processing functions as described herein.

The client device 400 also can include a communications interface 410 for communicating over communication network 250. In the event that the client device 400 wirelessly communicates over communication network 250, communications interface 410 may comprise a transceiver having one or more wireless transmitters and receivers that can modulate and demodulate signals to convert signals from one form to another, and can transmit and/or receive such signals over one or more various wireless communication networks. In illustration, the communications interface 410, and in particular the transceiver, can be configured to communicate data via IEEE 802 wireless communications, for example, 802.11 and 802.16 (WiMax), WPA, or WPA2. In another example, the transceiver can communicate data via GSM, TDMA, CDMA, WCDMA, OFDM, or direct wireless communication. Further, the transceiver also can be configured to communicate over a wireless communication link using any of a myriad of communications protocols, for example, TCP/IP. In operation, the transceiver can transmit requests generated by the mobile station and receive responses from the location-based services server.

The client device 400 also can include a user interface 420 comprising one or more tactile input devices 425 and a display 430. The tactile input devices 425 can comprise one or more buttons, keys, soft keys, sensors, or any other devices suitable for receiving a tactile user input. The display 430 can be a liquid crystal display (LCD), a liquid crystal on silicon (LCOS) display, a cathode ray tube (CRT), a plasma display, or any other suitable display. In one arrangement, the display 430 can comprise a touch screen that can receive tactile and/or stylus inputs and communicate such inputs to the processor 405. The tactile input devices 425 and/or display 430 can receive user inputs to establish user preferences, receive user selections, or perform any other suitable electronic device functions and allows a user to interact with applications 450 maintained in the data storage 415, including applications that are usable to permit the user to access a user account maintained on or in association with server 240, as described in greater detail below.

The user interface 420 further can include an audio processor 435 connected to an input audio transducer 440 (e.g. microphone) and an output audio transducer 445 (e.g. loudspeaker). The audio processor 435 can be integrated with the processor 405 or provided as a separate component that is communicatively linked to the processor 405. The audio processor 435 can comprise a CPU, a DSP, an ASIC, a PLD, a plurality of discrete components that cooperate to process audio data, and/or any other suitable audio processing device.

The audio processor 435 can receive output audio signals from the processor 405 and communicate such signals to the output audio transducer 445. Similarly, the audio processor 435 can receive input audio signals from the input audio transducer 440 and communicate such signals to the processor 405. In one arrangement, speech recognition can be implemented to process such signals. For example, the audio processor 435 can execute a speech recognition application to process audio signals containing user inputs that are received from the user.

Further, additional devices (not show) can be components of the user interface 420. For instance, the user interface 420 also can include a headset, a speakerphone, or other device(s) communicatively linked to the client device 400 via the transceiver 410, a second transceiver, and/or the communications port.

The data storage 415 can include one or more storage devices, each of which can include, but is not limited to, a magnetic storage medium, an electronic storage medium, an optical storage medium, a magneto-optical storage medium, and/or any other storage medium suitable for storing digital information. In one arrangement, the data storage 415 can be integrated into the processor 405, though this need not be the case.

The operating system 426 (e.g., Darwin, RTXC, LINUX, UNIX, OS X, Microsoft WINDOWS, Android or an embedded operating system such as VxWorks) may be contained in the data storage 415. The operating system 426 includes various software components and/or drivers for controlling and managing general system tasks (e.g., memory management, storage device control, power management, etc.) and facilitates communication between various hardware and software components.

Applications 450 such as one or more of the applications mentioned herein may also be contained in data storage 415. In addition, the data storage 415 may also contain a hardware-based identity manager (HIM) 440. The processor 405 can execute the applications 450, HIM 440 and operating system 426 to implement the processes and methods respectively allocated to them. For example, HIM 440 may be used instead of a password manager to authenticate the client device 400 to a server, such as server 240 in FIG. 1. Instead of using a password for authentication, HIM 440 uses a digital certificate and a private key. The HIM 440 operates in cooperation with the applications 450 and a secure, tamper-resistant hardware module 460 in order to implement the authentication process. Secure, tamper-resistant hardware module 460, sometimes referred to as a secure processing unit (SPU), provide a trusted environment for generating and storing cryptographic keys, encrypting and decrypting information and managing the secure communication of keys and other information between components of electronic devices.

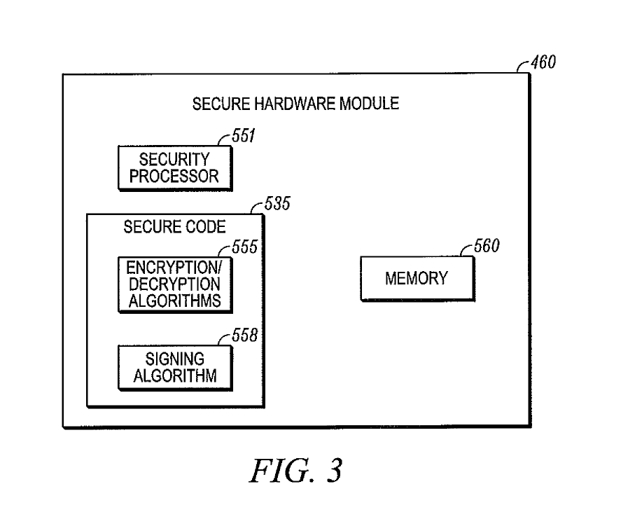

One example of the secure hardware module 460 is shown in FIG. 3. The secure hardware module 460 includes a security processor 551, a secure code 535, and a secure memory 560, such as a computer readable medium. In one embodiment, the secure hardware module 460 is a secure silicon hardware device, such as a tamper resistant silicon microchip. The security processor 551 is a secured processor having secure processing logic that handles the processing functions for the secure hardware module 460 described herein, such as the encryption and decryption of the private key received from the server and the signing of messages received from the server 240. The secure code 535 is a portion of the secure hardware module 460 that comprises various software code and applications that is executed by the security processor 551. Notably, secure code 535 includes encryption and decryption algorithms for encrypting and decrypting private keys received from the server 240 and an algorithm 558 for adding digital signatures to messages. Memory 560 is used to store, among other things, a device-specific key that may be randomly generated by the client device 400.

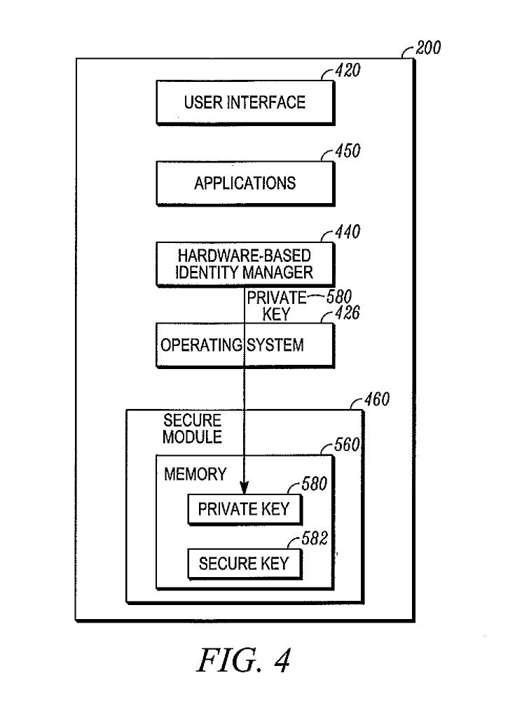

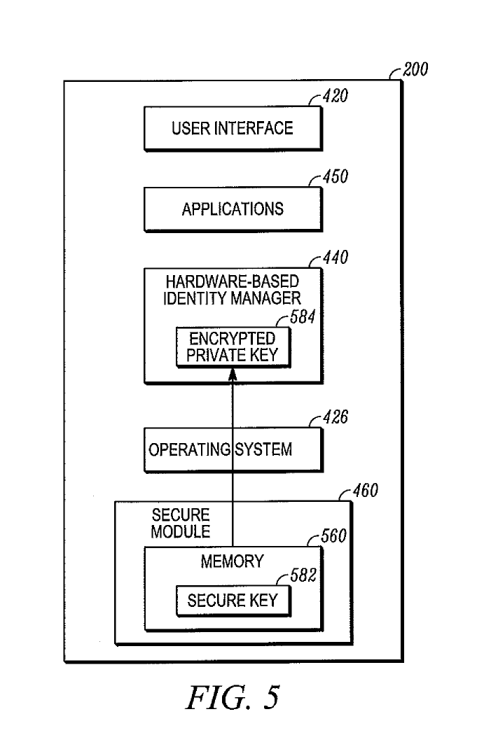

FIGS. 4-5 depict a high level architecture 200 of the pertinent components of the client device 400 shown in FIG. 2, which will be used to illustrate how a private key obtained from the server 240 is encrypted and securely stored by the client device 400 so that it cannot be misappropriated or otherwise accessed by an unauthorized party. In FIGS. 2 and 4, as well as the figures that follow, like elements are denoted by like reference numerals. As shown, architecture 200 includes operating system 426 supporting HIM 440, applications 450 and user interface 420. The operating system 426 interacts with a hardware layer 470, which may include, for instance, the processor 405, transceiver 410, secure module 460 and the various hardware elements of the user interface shown in FIG. 2 such as the tactile input device 425, display 430 and audio processor 435.

In FIG. 4 HIM 440 is shown as being in direct communication with application layer 450 and operating system 426. In some implementations, however, all or part of the functionality of the HIM 440 may be incorporated into the application layer 450 and/or the operating system 426. Locating HIM 440 within operating system 426 may be particularly convenient because HIM 440 needs to communicate with the secure module in the hardware layer 470 and in many devices only the operating system 426 can communicate with the hardware layer 470. Of course, FIG. 4 shows only one possible architecture of a device incorporating the subject matter of the present disclosure and more generally a wide variety of other architectures may be employed as well.

As a preliminary matter, when first establishing an account with a server (e.g., server 240), a user of client device 400 generally authenticates him or herself with a username and password. In response, the server generates a digital certificate linked to the client device and an associated private key 580. The server sends the digital certificate and private key to the client device, effectively exchanging the private key for the password supplied by the user.

The receipt of the private key 580 by the client device represents the only time that the private key is maintained on the client device in the clear. As shown by the process flow indicated by the arrow in FIG. 4, the private key 580 received by the client device is transferred (via operating system 426) to the memory 560 in the secure module 460. Of course, because the digital certificate is publically available, it can be stored in a conventional memory (e.g., data storage 450 in FIG. 2) and not necessarily the secure module 460.

Also shown in the memory 560 of the secure module 460 is a secure key 482. Secure key 582 is a key such as an Advanced Encryption Standard (AES) key that may be randomly generated by the HIM 440 when initializing the secure module 460. The secure key 582 is maintained in the secure module 460 at all times and thus is not even accessible to an administrator or root user of the operating system 426. The processor 551 in the secure module 460 encrypts the private key 580 using the secure key 582 to produce an encrypted private key 584 and transfers the encrypted private key to the HIM 440. The private key 580 then may be deleted from the memory of the secure module 460. Accordingly, the client device 400 only maintains the private key 480 in encrypted form and, as shown below, only decrypts it when necessary in the secure module 460 so that it is at no times accessible to an individual.

Once the HIM 440 has stored the encrypted private key along with its associated digital certificate, the client device 400 has the credentials it needs to subsequently access the server 240 without use of a password.

The process by which the client device establishes communication with the server using the certificate and private key as authentication credentials involves establishing a secure connection in which two-way authentication is employed. In two-way authentication the server authenticates itself to the client device and the client device authenticates itself to the server. Although a wide variety of secure protocols may be employed, the Transport Layer Security (TLS) protocol will be illustrated by way of example. The TLS protocol is a commonly used protocol for managing the security of message transmission over the Internet and other communication networks.

The TLS protocol uses a combination of public-key and symmetric key encryption. The TLS protocol includes a TLS handshake protocol to exchange a series of messages between the server and the client when they first establish a TLS connection. The TLS handshake allows the server to authenticate itself to the client and the client to authenticate itself to the server using public-key techniques, and then allows the client and the server to cooperate in the creation of symmetric keys used for encryption, decryption, and tamper detection during the ensuing TLS session. Once the TLS handshake has been completed the client device and server will have established an encryption algorithm and exchanged cryptographic keys which can be used to encrypt and decrypt data during a communication session.

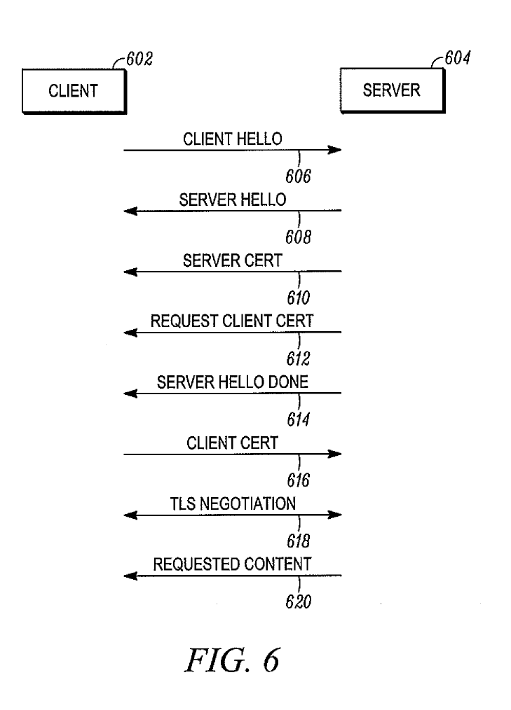

One illustrative example of the TLS message exchange process between a client device and server is shown in FIG. 6. It should be noted that the details of this message exchange process will depend on many factors that may differ from case to case. Accordingly, the message exchange process shown in FIG. 6 is presented for illustrative purposes only and should not be construed as limiting in any way. Moreover, the data included in the messages described above, as well as those discussed below, may be combined into a fewer number of messages or, in some cases, divided among a greater number of message.

As shown in FIG. 6, a client device 602, such as client devices 210, 220, and 230, and a server 604, such as server 240, negotiate a secured connection by using a handshaking procedure during which client device 602 and server 604 agree on various parameters used to establish the connection's security. First, client device 602 sends a ClientHello message 606 specifying the highest SSL/TLS protocol version it supports, a random number, a list of suggested cipher suites and compression methods.

Server 604 responds with a ServerHello 608, containing the chosen protocol version, a random message such as a random number, cipher suite, and compression method from choices offered by client device 602. Server 604 also sends its digital certificate 610. The server's digital certificate 610 may include the server's name, a trusted certificate authority (CA), and the server's public encryption key. Server 604 also requests, for example by use of a CertificateRequest 612, a certificate from client device 602 so that the connection can be mutually authenticated. The CertificateRequest 612 also requests that client device 602 return a digitally signed random message, and in particular a digitally signed copy of the random number sent to the client device in ServerHello 608. The random message is to be signed using the client device's private key 580, and in particular a private key associated with the appropriate account on server 604. Server 604 sends a ServerHelloDone message 614, indicating that it has completed the handshake negotiation. In response, client device 602 sends a client certificate and the digitally signed random message 616 to server 604.

In order to sign the random message from the server, the client device 602 decrypts its private key within its secure module 460 and uses the private key to sign the message, also within the secure module. Additional details concerning the manner in which client device 602 decrypts its signed key and signs the random message from the server will be discussed below, after completing the discussion of the illustrative TLS message exchange process.

After server 604 has authenticated client device 602 and client device 602 has authenticated server 604 in the manner described above, the TLS message exchange process continues with a TLS negotiation 618 between client device 602 and server 604. This process may involve client device 602 sending a ClientKeyExchange message, which may contain a PreMasterSecret and a public key, and client device 602 and server 604 use the PreMasterSecret to compute a common secret, called the “master secret.” All other key data is derived from this master secret (and client- and server-generated random values), which is passed through a “pseudorandom function.” The client device then sends a ChangeCipherSpec message, essentially telling the Server, “Everything I tell you from now on will be encrypted.”

The manner in which client device 602 signs the random message received from server 604 will be illustrated with reference to the client architecture 200 discussed above in connection with FIGS. 4-5, which were used to illustrate the manner in which the client obtained and stored the digital certificate and private key from the server when establishing an account with the server.

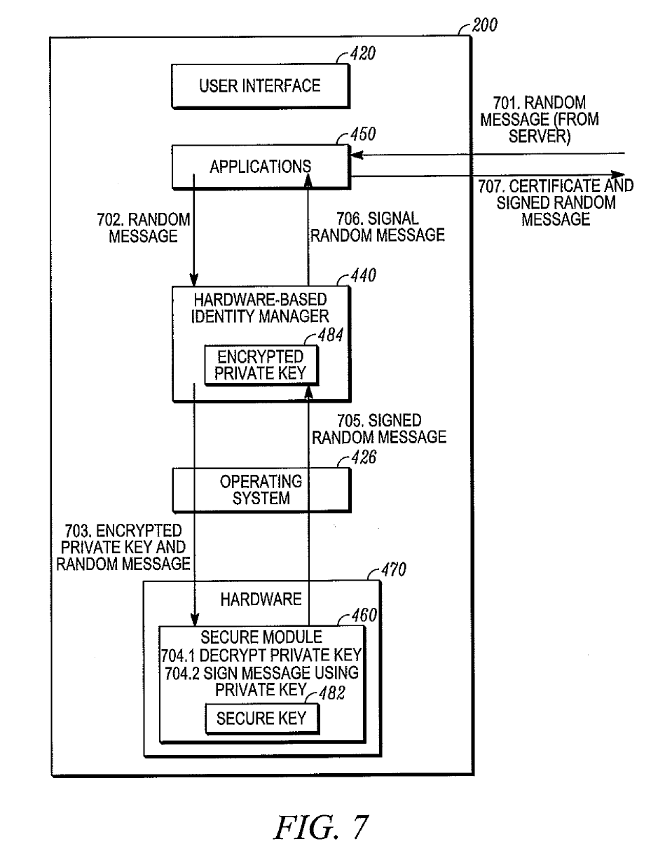

FIG. 7 depicts a process flow, within the context of the client device architecture 200 depicted in FIG. 4, that may be used by the client device 602 when logging onto the server 604. At step 701, the random message is received from the server as part of the secure protocol (e.g., TLS) used to establish communication between the server and the client device. The random message is typically received by the appropriate client application 150 that communicates with the server. At step 702, the client application passes the random message to the HIM 440. At step 703, the HIM 440 provides the random message and the encrypted private key 484 to the secure module 460 (typically via operating system 426). When HIM 440 stores multiple private encrypted keys, each of which is associated with a different user account on one or more servers, the HIM selects (for decryption) an encrypted private keys that is associated with the corresponding user account on the server 604, e.g., a first private encrypted key that is, in turn, associated with a corresponding first user account of the multiple user accounts.

Next, at step 704.1, the secure module 460 decrypts the encrypted private key using the secure key 482 stored in its secure memory. The secure module 460 then uses the decrypted private key to sign the random message, at step 704.2. The secure module 460 provides the signed random message to HIM 440 (typically via operating system 426). Thus, at no time is the encrypted private key available in decrypted form outside of the secure module 460. HIM 440, in turn, passes the signed random message to the appropriate application, at step 706. Finally, at step 707, the application sends the signing random message, along with the associated digital certificate, to the server, thereby providing the server with the authentication credentials needed to access the client account associated with the server.

As FIG. 7 illustrates, at no point during the login process is the private key ever in the clear. Accordingly, the private key is not readily susceptible to being misappropriated in the manner that a password or the like can be misappropriated. It should be noted, however, that if the client device is lost or stolen by a third party, the third party can use the client device to login to the server and access the client account. Nevertheless, the user can avoid or limit the potential harm by subsequently accessing the server account in the conventional manner using the original username and password and revoking or otherwise invalidating the digital certificate and private key. In this way the third party will no longer be able to access the account.

FIG. 7 shows the HIM 440 storing a single encrypted private key 484, which is used to access a particular user account on or associated with a server. More generally, HIM 440 may store any number of encrypted private keys, each of each which may be associated with a different user account or application 450. The various user accounts may be associated with a common server or different servers offering a variety of different services. Moreover, the encrypted private keys may be used to allow different applications 450 to communicate with the server, for example, with the user accounts, in a secure manner. Of course, in some cases multiple keys may be used by a common application.

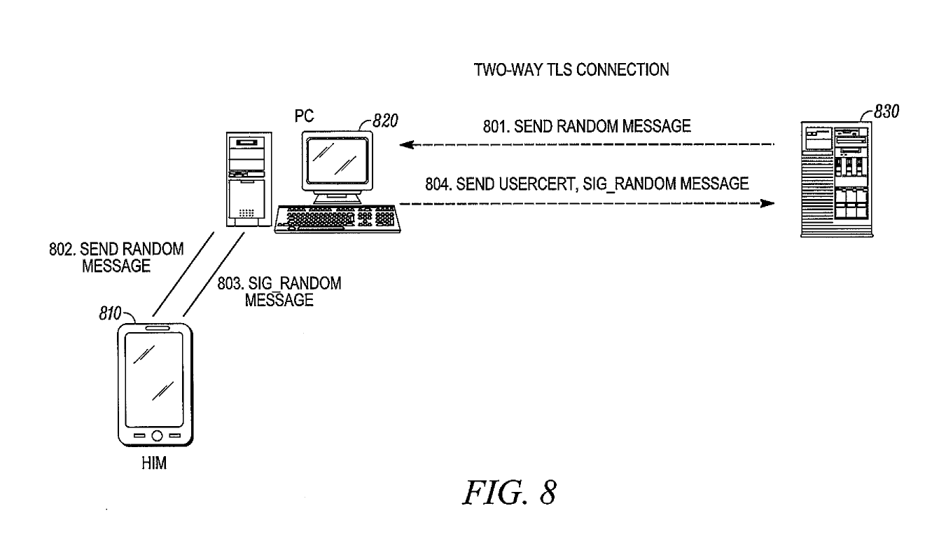

In the examples described above the HIM is implemented on the client device that is to access the user account on the server. However, in some implementations a client device equipped with a HIM can be used by a second client device so that the second client device can access the user account on the server. Referring now to FIG. 8, a process flow is depicted in which a HIM hosted on a first client device 810, such as mobile device 210, is used to allow an application hosted on a second client device 820, such as PC 230, to access an account on a server 830, such as server 240. In the process flow depicted in FIG. 8, at step 801, the server 830 sends a random message to the second client device 820 as part of the process of establishing the secure connection between the second client device 820 and the server 830. The second client device 820, in turn, passes the random message to the first client device 810, at step 802. Communication between the second client device 820 and the first client device 810 may be established using any suitable protocol and physical medium, both wired and wireless. For example, in one implementation a cable conforming to the Universal Serial Bus (USB) protocol may be employed. In other implementations a wireless connection may be established using, for example, Near-Field Communication (NFC) or Bluetooth. In yet other implementations the first client device 810 may serve as a hardware dongle or key that plugs into a connector or port on the second client device 820.

After receiving the random message from the second client device 820, the first client device 810 signs the message in the manner described above and then passes the signed message back to the second client device 820, at step 803. The first client device 810 may also optionally send the appropriate digital certificate to the second client device 820. The second client device 820, in turn, sends the signed message and the digital certificate (which it obtained from the first client device 810 or which it stores locally) to the server 830, at step 804. In this way the second client device 820 provides the necessary authorization credentials used to access the user account on the server 830.

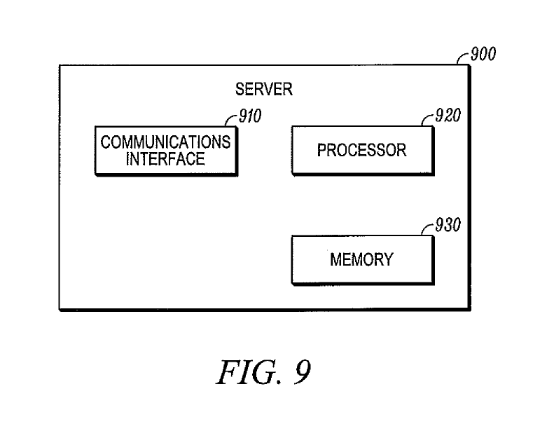

FIG. 9 depicts a block diagram of an example of a server 900, such as server 240 in FIG. 1, server 604 in FIG. 6 and server 830 in FIG. 8, which is useful for understanding the present invention. Server 900 includes a memory 930, one or more communications interfaces 910, and a processor 920 operatively coupled to the one or more communications interfaces for performing the functionality of the server 900. The communications interface 910 can be wired, wireless, or a combination of both (examples of which are given above) depending on the particular network to which the server 900 is connected. The processor 920 may be programmed with processing logic or code to perform the functions described herein as being performed by the server, wherein the logic is stored as software and or firmware in the memory 930 (examples of which are given above). Alternatively, or in addition to, the processor 920 may be implemented as a state machine or an application-specific integrated circuit (ASIC).

The processes described above, including but not limited to those shown in FIGS. 4-8, may be implemented in a general, multi-purpose or single purpose processor. Such a processor will execute instructions, either at the assembly, compiled or machine-level, to perform that process. Those instructions can be written by one of ordinary skill in the art following the description herein and stored or transmitted on a computer readable storage medium. The instructions may also be created using source code or any other known computer-aided design tool. A computer readable storage medium may be any physical medium capable of carrying those instructions and include a CD-ROM, DVD, magnetic or other optical disc, tape, and silicon memory (e.g., removable, non-removable, volatile or non-volatile).

Although various embodiments are specifically illustrated and described herein, it will be appreciated that modifications and variations of the present invention are covered by the above teachings and are within the purview of the appended claims without departing from the spirit and intended scope of the invention.

1. A method for providing authentication credentials to a server over a communications network, comprising:
initiating communication with a server over a communications network, said communication to be established using a secure connection;
receiving over the communications network a message from the server and a request for a digital certificate associated with a first user account accessible to the server;
decrypting in a secure hardware module an encrypted private key to obtain a decrypted private key, said decrypted private key being associated with the first user account;
passing the message received from the server to the secure hardware module;
digitally signing the message in the secure hardware module using the decrypted private key; and
sending the digital certificate and the digitally signed message to the server over the communication network.

2. The method of claim 1 further comprising storing a secure key in the secure hardware module and decrypting the encrypted private key using the secure key.

3. The method of claim 2 wherein the encrypted private key includes a plurality of encrypted private keys and further comprising:
storing the plurality of encrypted private keys, each of said encrypted private keys being associated with a different user account on one or more servers;
selecting for decryption a first of the encrypted private keys which is associated with the first user account.

4. The method of claim 3 wherein each of the encrypted private keys is encrypted in the secure hardware module using the secure key.

5. The method of claim 4 wherein, after being encrypted, the encrypted private key is at no time available in decrypted form outside of the secure hardware module.

6. The method of claim 1 wherein the secure connection conforms to a TLS protocol.

7. The method of claim 1 wherein the secure hardware module is located in a first client device and the secure connection with the server is established using a second client device and further comprising sending the digitally signed message from the first client device to the second client device such that the digital certificate and the digitally signed message are sent to the server by the second client device so that the first user account is accessible to the second client device.

8. The method of claim 1 wherein the encrypted private key is encrypted and decrypted in the secure hardware module and resides in decrypted form only in the secure hardware module and not outside of the secure hardware module.

9. The method of claim 1 further comprising establishing the first user account by sending to the server one or more of a username and a password and, in response thereto, receiving the digital certificate and the private key from the server.

10. The method of claim 9 further comprising accessing the first user account using the one or more of the username and password and revoking the digital certificate and private key using the username and/or password.

11. A client device, comprising:
a communications interface for communicating over a communication network;
one or more processors for executing machine-executable instructions;
one or more machine-readable storage media for storing the machine-executable instructions, the instructions including an identity manager for facilitating provision of authentication credentials to a server over the communications network; and
a secure hardware module operatively associated with the identity manager, said secure hardware module having a secure memory and secure processing logic configured to decrypt an encrypted private key to obtain a decrypted private key, said decrypted private key being associated with a user account accessible over a communications network, said secure processing logic being further configured to digitally sign a message received from the server, said authentication credentials including the digitally signed message.

12. The client device of claim 11 wherein the identity manager is configured to store the encrypted private key and provide it to the secure hardware module when accessing the user account such that at no time is the encrypted private key available in decrypted form outside of the secure hardware module.

13. The client device of claim 11 further comprising a user interface, wherein the machine-readable instructions further include at least one application with which a user can interact using the user interface, said application being usable to access the user account.

14. The client device of claim 11 wherein the machine-readable instructions include a plurality of applications and the identity manager is configured to store at least one encrypted private key for each of the applications.

15. The client device of claim 11 wherein the communication interface includes one or more wireless transmitters and receivers for communicating over a wireless communication network.

16. The client device of claim 11 wherein the machine-executable instructions further includes an operating system, at least a portion of functionality associated with the identity manager being incorporated into the operating system.

17. The client device of claim 11 wherein the identity manager is configured to initialize the secure hardware module by causing a secure key to be randomly generated and stored in the secure memory of the secure hardware module, said secure key being used within the secure memory to encrypt and decrypt the private key.

18. The client device of claim 11 wherein the client device is a mobile device, said communication interface being configured to communicate with a second client device, said identity manager being further configured to communicate the digitally signed message to the second client device which is configured to send the digitally signed message to the server over the communications network to access the user account.

19. The client device of claim 11 wherein the authentication credentials are used as part of a process to establish a secure connection between the client device and the server.

20. A server, comprising:
a communications interface for communicating over a communication network;
a processor operatively associated with the communications interface, said processor including processing logic configured to: (i) communicate with a client device over a communications network, said communication to be established using a secure connection; (ii) send to the client device over the communications network a message and a request for a digital certificate associated with a user account of the client device; (iii) receive from the client device the digital certificate and an encrypted version of the message encrypted using the private key; and (iv) in response to receipt of the digital certificate and the encrypted version of the message, establish the secure connection and allow the client device to access the user account

21. The server of claim 20 wherein, prior to establishment of the secure connection, the processing logic is further configured to establish a user account by sending the client device over the communications network the digital certificate and the private key to serve as authentication credentials for accessing the user account.

22. The server of claim 20 wherein the processing logic is further configured to establish the user account using, at least in part, a username and/or password received from the client device and to send the digital certificate and the private key in response to receipt of the password.
